(19) United States
(12) Patent Application Publication
(10) Pub. No.: US 2015/0036179 A1
(43) Pub. Date: Feb. 5, 2015

(54) SEARCH INTERFACE DEVICE AND ELECTRONIC DEVICE

(71) Applicant: KYOCERA DOCUMENT SOLUTIONS INC., Osaka (JP)

(72) Inventor: Kenta Nakatsu, Osaka (JP)

(21) Appl. No.: 14/338,924

(22) Filed: Jul. 23, 2014

(30) Foreign Application Priority Data
Jul. 31, 2013 (JP) 2013-158694

(51) Int. Cl. H04N 1/00; G06F 3/041

(52) U.S. Cl. CPC H04N 1/00392; G06F 3/0416; H04N 1/00411; H04N 1/00413; H04N 2201/0094
USPC 358/1.15; 345/173

(57) ABSTRACT

An interface device is equipped with a touch panel and a search character input portion, and is used for inputting characters for searching search target data. The touch panel has a display surface including a search result display area for displaying a search result and a character display area for input which displays a character string for input, and detects a pressed position with respect to the display surface. The search character input portion inputs, in response to movement of the pressed position in a state that the pressing on a plurality of characters included in the character group for input displayed in the character display area for input is maintained, the character corresponding to the pressed position sequentially as a search character.

### INCORPORATION BY REFERENCE

This application is based upon and claims the benefit of priority from the corresponding Japanese Patent Application No. 2013-158694 filed on Jul. 31, 2013, the entire contents of which are incorporated herein by reference.

### BACKGROUND

This disclosure relates to a search interface device and an electronic device including the search interface device.

In offices and other places, multifunction peripherals (MFP) including functions of a scanner, a facsimile, a printer, a copying machine and other components are used. In such a multifunction peripheral, address books are mounted in association with a facsimile, file transmission and like data transmission functions. As is well known, an address book stores address information which shows facsimile numbers, e-mail addresses, network addresses and other destinations of data transmission, and destination information which shows the names, titles and the like of the destinations of data transmission in association with each other. A search function is provided in order to extract desired destinations in such an address book.

Such a search is executed by an operation device provided in the multifunction peripheral. In recent years, a touch panel is widely used as the operation device. As is well known, a touch panel is equipped with the feature of a display device and the feature of an input device, and displays operation buttons and the like, while detecting a pressed position (touched position) with sensors and the like disposed at a display surface. Operation devices equipped with such a touch panel are employed not only in multifunction peripherals but also in various devices. In addition, various techniques have been suggested to increase the search convenience of users.

For example, there is known a user interface device which, when fifty hiragana characters are displayed in the order of the Japanese syllabary on a search screen and any of the hiragana characters are pressed, increases the vertical width of a column including the character; moves the display location of the character to the left end of the column; increases the size of the font and make other adaptations so that the selected character is enlarged and displayed in a position which is not hidden by a finger.

In addition, a portable electronic device with increased operability in advanced search for retrieving files contained in folders is also known.

### SUMMARY

A search interface device according to an aspect of this disclosure is equipped with a touch panel and a search character input portion, and is used for inputting characters for searching search target data. The touch panel has a display surface including a search result display area for displaying a search result and a character display area for input which displays a character group for input, and detects a pressed position on the display surface. The search character input portion inputs, in response to movement of the pressed position in a state that the pressing on a plurality of characters included in the character group for input displayed in the character display area for input is maintained, the character corresponding to the pressed position sequentially as a search character.

An electronic device according to another aspect of this disclosure is equipped with the interface device.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a schematic block diagram showing the overall structure of a multifunction peripheral in one embodiment of this disclosure.

FIG. 2 is a diagram showing the hardware constitution of a multifunction peripheral in one embodiment of this disclosure.

FIG. 3 is a functional block diagram showing a multifunction peripheral in one embodiment of this disclosure.

FIG. 4 is a diagram showing an example of a search screen displayed by a search interface device of a multifunction peripheral in one embodiment of this disclosure.

FIG. 5 is a flowchart showing an example of search character input procedure performed by a search interface device of a multifunction peripheral in one embodiment of this disclosure.

FIG. 6 is a diagram showing an example of search character input in a search interface device of a multifunction peripheral in one embodiment of this disclosure.

FIG. 7 is a diagram showing an example of search character input in a search interface device of a multifunction peripheral in one embodiment of this disclosure.

FIG. 8 is a diagram showing an example of search character input in a search interface device of a multifunction peripheral in one embodiment of this disclosure.

FIG. 9 is a diagram showing an example of search character input in a search interface device of a multifunction peripheral in one embodiment of this disclosure.

FIG. 10 is a diagram showing another example of a search screen displayed by a search interface device of a multifunction peripheral in one embodiment of this disclosure.

FIG. 11 is a flowchart showing another example of a search character input procedure performed by a search interface device of a multifunction peripheral in one embodiment of this disclosure.

FIG. 12 is a diagram showing an example of search character input in a search interface device of a multifunction peripheral in one embodiment of this disclosure.

FIG. 13 is a diagram showing an example of search character input in a search interface device of a multifunction peripheral in one embodiment of this disclosure.

FIG. 14 is a diagram showing an example of search character input in a search interface device of a multifunction peripheral in one embodiment of this disclosure.

FIG. 15 is a diagram showing an example of search character input in a search interface device of a multifunction peripheral in one embodiment of this disclosure.

FIG. 16 is a diagram showing an example of search character input in a search interface device of a multifunction peripheral in one embodiment of this disclosure.

FIG. 17 is a diagram showing an example of search character input in a search interface device of a multifunction peripheral in one embodiment of this disclosure.

### DETAILED DESCRIPTION

One embodiment of this disclosure will be described below in detail with reference to drawings. This disclosure will be embodied below as a digital multifunction peripheral.

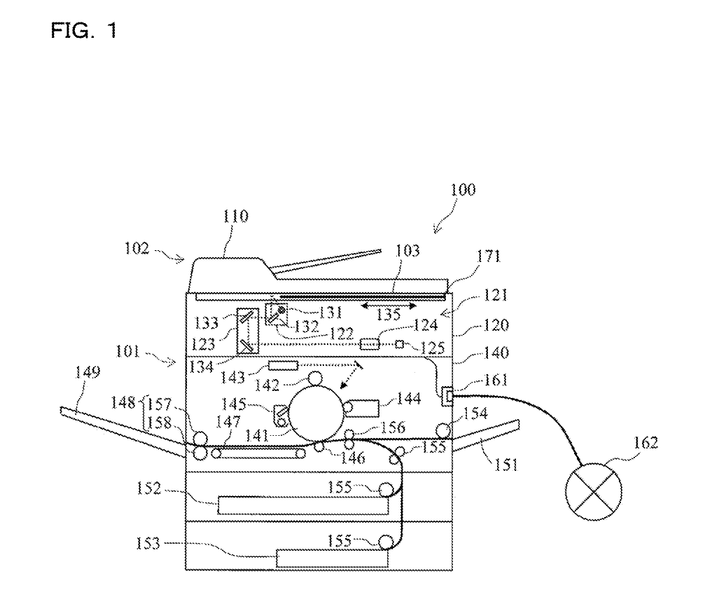

FIG. 1 is a schematic block diagram showing an example of the overall structure of the digital multifunction peripheral in this embodiment. As shown in FIG. 1, a multifunction peripheral 100 includes a body 101 including an image reading portion 120 and an image forming portion 140, and a platen cover 102 attached to an upper portion of the body 101. A document table 103 composed of a transparent plate such as contact glass and the like is provided on the body 101, and the document table 103 is configured to be opened and closed by the platen cover 102. In addition, the platen cover 102 is provided with a document feeder 110. On the front face of the multifunction peripheral 100 is provided an operation panel 171 which allows the user to give the multifunction peripheral 100 instructions to start photocopying and perform other operations and to confirm the state and setting of the multifunction peripheral 100.

The image reading portion 120 is provided below the document table 103. The image reading portion 120 reads an image of a document by a scanning optical system 121 and produces a digital data (image data) of the image. The document can be placed on the document table 103 and the document feeder 110. The scanning optical system 121 is equipped with a first carriage 122, a second carriage 123, and a condensing lens 124. The first carriage 122 is provided with a linear light source 131 and a mirror 132, while the second carriage 123 is provided with mirrors 133 and 134. The light source 131 illuminates the document. The mirrors 132, 133, 134 guide a reflected light from the document to the condensing lens 124, and the condensing lens 124 forms an image of the optical image on a light receiving face of a line image sensor 125.

In this the scanning optical system 121, the first carriage 122 and the second carriage 123 are provided reciprocatably in a subscanning direction 135. By moving the first carriage 122 and the second carriage 123 in the subscanning direction 135, the image of the document placed on the document table 103 can be read by the image sensor 125. When reading the image of the document set in the document feeder 110, the image reading portion 120 aligns the first carriage 122 and the second carriage 123 with an image reading position, temporarily halts the carriages, and reads the image of the document which passes the image reading position by the image sensor 125. The image sensor 125 generates the image data of the document from the optical image which is incident on the light receiving face.

The generated image data can be printed on a paper sheet in the image forming portion 140. In addition, the generated image data can be also transmitted to another device (not shown) through a network 162 via a network interface 161 and the like.

The image forming portion 140 prints the image data obtained in the image reading portion 120 and the image data received from another device connected to the network 162 via the network interface 161, on a paper sheet.

The image forming portion 140 includes a photoreceptor drum 141. The photoreceptor drum 141 rotates at a constant speed in one direction. Around the photoreceptor drum 141, in the order from the upstream side in the rotation direction, a charging portion 142, a exposure portion 143, a developing portion 144, and a cleaning unit 145 are disposed. The charging portion 142 uniformly electrifies the surface of the photoreceptor drum 141. The exposure portion 143 irradiates the surface of the uniformly electrified photoreceptor drum 141 with a light beam correspondingly to the image data, and forms an electrostatic latent image on the photoreceptor drum 141. The developing portion 144 deposits toner onto the electrostatic latent image to form a toner image on the photoreceptor drum 141. The cleaning unit 145 removes waste toner still remaining on the surface of the photoreceptor drum 141 after the transfer from the photoreceptor drum 141 to clean the surface of the photoreceptor drum 141. These processes are serially performed by the rotation of the photoreceptor drum 141.

The image forming portion 140 feeds a paper sheet to a transfer portion between the photoreceptor drum 141 and a transfer roller 146 from a manual feed tray 151, paper cassettes 152, 153 and like components. Variously sized paper sheets can be placed or accommodated in the manual feed tray 151 and each of the paper cassettes 152, 153. The image forming portion 140 selects the paper designated by the user and paper depending on an automatically detected size of the document, and feeds the selected paper by a feeding roller 155 from the manual feed tray 151 and cassettes 152, 153. The paper fed is transferred to the transfer portion at a predetermined timing by the conveyance roller 155 and a registration roller 156. The paper sheet onto which a toner image is transferred is transferred to a fixing device 148 by a conveyance belt 147. The fixing device 148 has a fixing roller 157 having a heater incorporated therein, and a pressure roller 158, and fixates the toner image onto the paper sheet by heat and pressure. The image forming portion 140 discharges the paper sheet which has passed the fixing device 148, into a paper discharge tray 149.

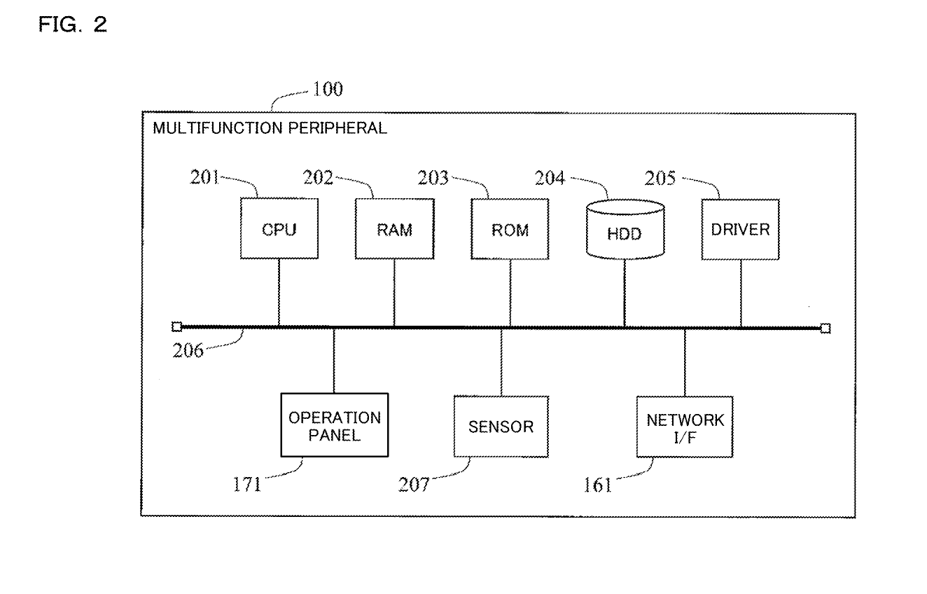

FIG. 2 is a hardware structure chart of a control system in a multifunction peripheral. In the multifunction peripheral 100 of this embodiment, a CPU (Central Processing Unit) 201, a RAM (Random Access Memory) 202, a ROM (Read Only Memory) 203, an HDD (Hard Disk Drive) 204 and drivers 205 that correspond to the driving portions in the document feeder 110, the image reading portion 120 and the image forming portion 140 are connected via an internal bus 206. The ROM 203, HDD 204 and other components contain programs, and the CPU 201 controls the multifunction peripheral 100 according to the commands of the control program. For example, the CPU 201 utilizes the RAM 202 as an operation area, and provides to and receives from the driver 205 data and instructions to control the operations of the driving portions mentioned above. In addition, the HDD 204 is also used to accumulate the image data obtained by the image reading portion 120 and image data received from other devices through the network interface 161.

The operation panel 171, the network interface 161, and various sensors 207 are also connected to the internal bus 206. The operation panel 171 accepts the operations of the user, and provides signals to the CPU 201 based on the operations. The operation panel 171 displays an operation screen on a display (touch panel) provided on itself according to control signals from the CPU 201. The sensor 207 includes an opening and closing detection sensor of the platen cover 102, a document detection sensor on the document table 103, a temperature sensor of the fixing device 148, a detection sensor of transferred paper sheets or documents and like various sensors.

The CPU 201, for example, realizes the following respective portions (function blocks) by executing a program contained in the ROM 203, and controls the operations of the respective portions in response to signals from these sensors.

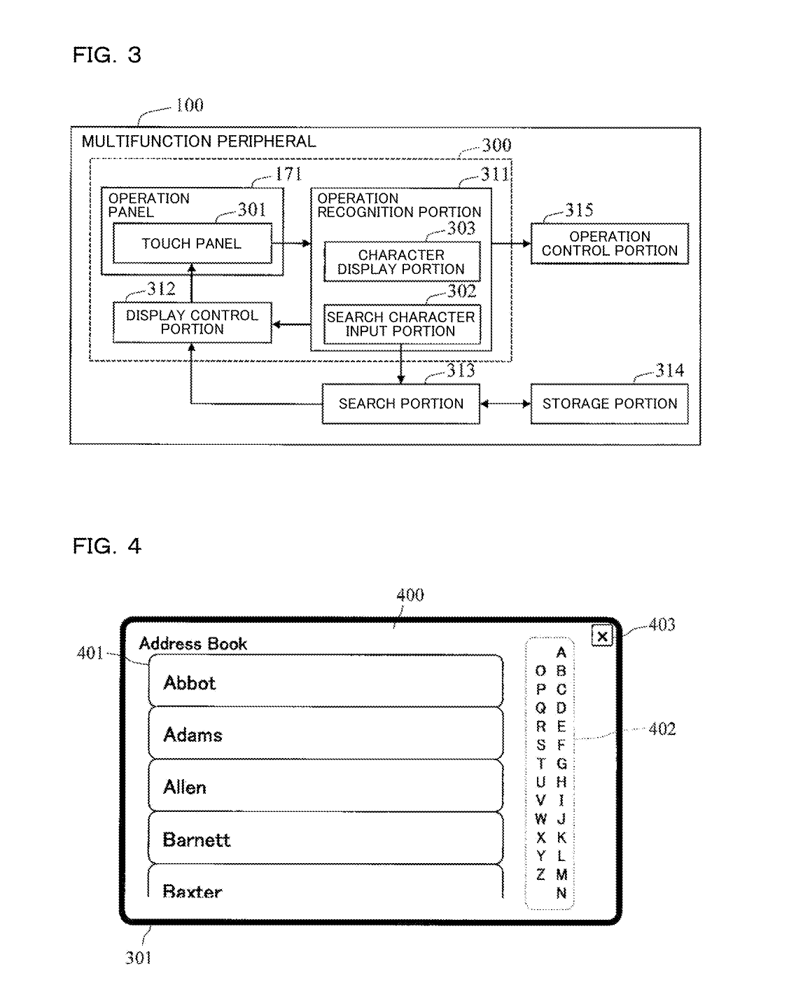

FIG. 3 is a functional block diagram of the multifunction peripheral of this embodiment. As shown in FIG. 3, the multifunction peripheral 100 of this embodiment is provided with a touch panel 301 which displays an operation screen on the operation panel 171, an operation recognition portion 311, and an display control portion 312. In this example, these components constitute a search interface device 300.

The touch panel 301 includes a display surface and sensors. The display surface is a liquid crystal display or the like for simultaneously displaying a search result display area for displaying the search result and a character display area for input which displays a character group for input. The sensors are capable of detecting a pressed position on the display surface. The method for detecting the pressed position is not limited in particular. The resistance film method, electrostatic capacity method, surface acoustic wave method, electromagnetic wave method and other optional methods can be employed. The user can perform input through the touch panel 301 using his/her own fingers, a touch pen or by other means.

By the way, in order to dispose an input interface employing button intervals and the like which take into consideration the use by the user with fingers requires a certain degree of screen size. However, due to integrated devices and the like, limitations on costs and sizes, and functional limitation and various other limitations, installment of a touch panel with a large screen size is often difficult. When a touch panel with a small screen size is employed, disposing an input interface having many operation buttons on the touch panel narrows the display area for the search result, which lowers visibility. For example, when a software keyboard (full keyboard) is disposed as an input interface, inputting of characters is easy, but the display area for the search result is decreased, which lowers visibility.

In addition, displaying the search character input screen and search result display area on different screens can ensure the visibility of the search result. However, in searching, it is possible that repeated search is performed by varying search criteria, and if the search character input area and search result display area are displayed on different screens, the operability is lowered. Disposing a hard key as an input interface can be also considered. However, it is possible to display various operation buttons depending on the respective functions equipped with the operation target device on the display surface of the touch panel, and therefore there is a tendency that hard keys are eliminated in operation devices including touch panels. Accordingly, disposing hard keys is also undesirable. In contrast, in the touch panel 301 of the multifunction peripheral 100 according to this disclosure, operability is not impaired even if it employs a small sized screen.

FIG. 4 is a diagram showing an example of the search screen displayed on the display surface of the touch panel 301 when a search is executed. As shown in FIG. 4, a search screen 400 includes a search result display area 401, a character display area for input 402 and a forcible search termination button 403.

The search result display area 401 displays the result of the search of the search target data with a search target character string. In the example shown in FIG. 4, the search target data is address book data including address information which shows facsimile numbers, e-mail addresses, network addresses and other destinations of data transmission, destination information which shows the names, titles and the like of the destinations of data transmission stored in association with each other. Herein, a state that a search character string has not been input is shown. Although not particularly limited, in this example, in such a situation that the search character string has not been input, it is so configured that the destination information which constitutes the address book data are displayed in the alphabetical order in the search result display area 401. It should be noted that in the search result display area 401, the search result display area 401 can be moved in the vertical direction in FIG. 4 by dragging on the search result display area 401, and the data which is not displayed in the display surface of the touch panel 301 can be displayed in the display surface of the touch panel 301.

The character display area for input 402 displays a character group for input. In this example, twenty six alphabets are displayed as a character group for input. As will be described later, the user inputs search characters by pressing on characters included in the character group for input displayed in the character display area for input 402.

The forcible search termination button 403 is used to forcibly terminate the search screen 400. That is, when the forcible search termination button 403 is pressed, the search screen 400 is terminated, and a menu screen and the like are displayed on the display surface of the touch panel 301.

The operation recognition portion 311 recognizes the pressing of the touch panel 301, and recognizes the contents of the user's operation. In addition, the operation recognition portion 311 displays various operation screens on the display surface of the touch panel 301 through the display control portion 312. In this embodiment, the coordinate of the pressed position detected by a sensor which detects a pressed position of the touch panel 301 is input in the operation recognition portion 311, and the operation recognition portion 311 recognizes the contents of the user's operation on the touch panel 301 based on the coordinate of the screen element of the operation buttons and the like retained by itself and the coordinate of the pressed position input. In this embodiment, the operation recognition portion 311 includes a search character input portion 302 and a character display portion 303. The search character input portion 302 and the character display portion 303 recognize operations relating to the input of search characters among the contents of the operation of by the user on the touch panel 301.

The search character input portion 302 inputs the character corresponding to the pressed position sequentially as a search character in response to the movement (dragging) of the pressed position in a state that the pressing on a plurality of characters included in the character group for input displayed in the character display area for input 402 is maintained. Although not particularly limited, in this embodiment, the search character input portion 302 inputs, when the pressed position moves in a state that the pressing on a plurality of characters included in the character group for input displayed in the character display area for input 402 is maintained, the character corresponding to the pressed position on which the halt of the movement is maintained for a predetermined period of time is input sequentially as a search character. Accordingly, when pressed position moves from one character to another, in the course of the movement, even when a non-target character is gone through, the non-target character can be prevented from being input as the search character.

The character specified by the search character input portion 302 is input sequentially in a search portion 313. The search portion 313 extracts data (records) including the search character from the search target data (herein, address book data) contained in a storage portion 314 and constituted by the HDD 204, and displays the destination information which is the result of the extraction in the search result display area 401 via the display control portion 312.

The character display portion 303 displays, when the pressed position is located on the character included in the character group for input, the target character which is input as the search character. This embodiment is so configured that when the pressed position is located on the character, the character is displayed on the side of the pressed position. The display method is not in particularly limited. It can be displayed in another location on the touch panel 301, or any display method may be employed.

The operation recognized by the operation recognition portion 311 is input in an operation control portion 315 according to need. The operation control portion 315 executes various processes in the multifunction peripheral 100 such as generation of the image data in the image reading portion 120 and printing and the like of the image data in the image forming portion 140, in response to the operation recognized by the operation recognition portion 311.

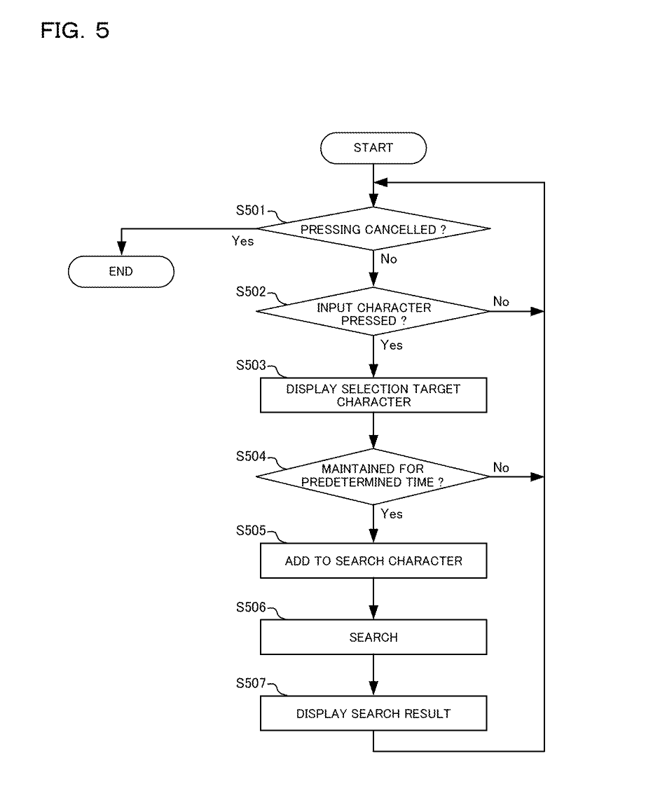

FIG. 5 is a flowchart showing an example of a search character input procedure performed by the search interface device 300. In the procedure, for example, the search screen 400 stated above is displayed by the selection on a menu screen on the touch panel 301, and is started upon a trigger of the detection of pressing in the search screen 400. Herein, a case where the destination of transmission of a facsimile is searched from an address book data and designated will be described.

When the procedure starts, the search character input portion 302 waits until a character included in the character group for input displayed in the character display area for input 402 is pressed on the touch panel 301 (step S501: No, S502: No). When the character is pressed, the search character input portion 302 recognizes the character, and notifies the character display portion 303 of the recognized character (step S501: No, S502: Yes). The notified character display portion 303 displays the notified character which is a target of selection on the touch panel 301 (step S503).

At this time, the search character input portion 302 determines whether the pressing on the character lasted (the movement of the pressed position has stopped on that character) for a predetermined period of time (for example, 0.5 to 1 second, hereinafter referred to as minimum pressing time) (step S504). When the pressing does not last for the minimum pressing time or longer, the search character input portion 302 waits until a character included in the character group for input is pressed (step S504: No, S501: No, S502: No).

In contrast, when it is determined that the pressing has lasted for the minimum pressing time or longer, the search character input portion 302 designates the character as a search character (step S504: Yes, S505). The search character input portion 302 which has designated the search character inputs the designated character in the search portion 313. Herein, the designated character is the first character, and therefore only one character is input in the search portion 313. In response to the input, the search portion 313 extracts the data including the search character from the search target data contained in the storage portion 314, and displays the extracted result in the search result display area 401 (step S506, S507).

The search character input portion 302 repeats the procedure stated above while the pressing state is maintained (S501: No). For example, when the pressed position moves while the pressing state is still maintained, and moves onto another character, the character being the target of selection is displayed on the touch panel 301 by the character display portion 303 (step S503).

The search character input portion 302 determines whether the pressing on the character has lasted for the minimum pressing period or longer, and when it is determined that the pressing has lasted for the minimum pressing time or longer, designates the character as a search character (step S504: Yes, S505). The search character input portion 302 which has designated the search character inputs a character string composed of the newly designated character with the previously designated character added thereto, in the search portion 313. Herein, the designated character is the second character, and therefore, a character string composed of the previously designated first character and the second character is input in the search portion 313.

In response to the input, the search portion 313 extracts the data including the search character from the search target data contained in the storage portion 314, and displays the extracted result in the search result display area 401 (step S506, S507).

When the pressing has been cancelled in the process of the above procedure, the procedure ends (step S501: Yes).

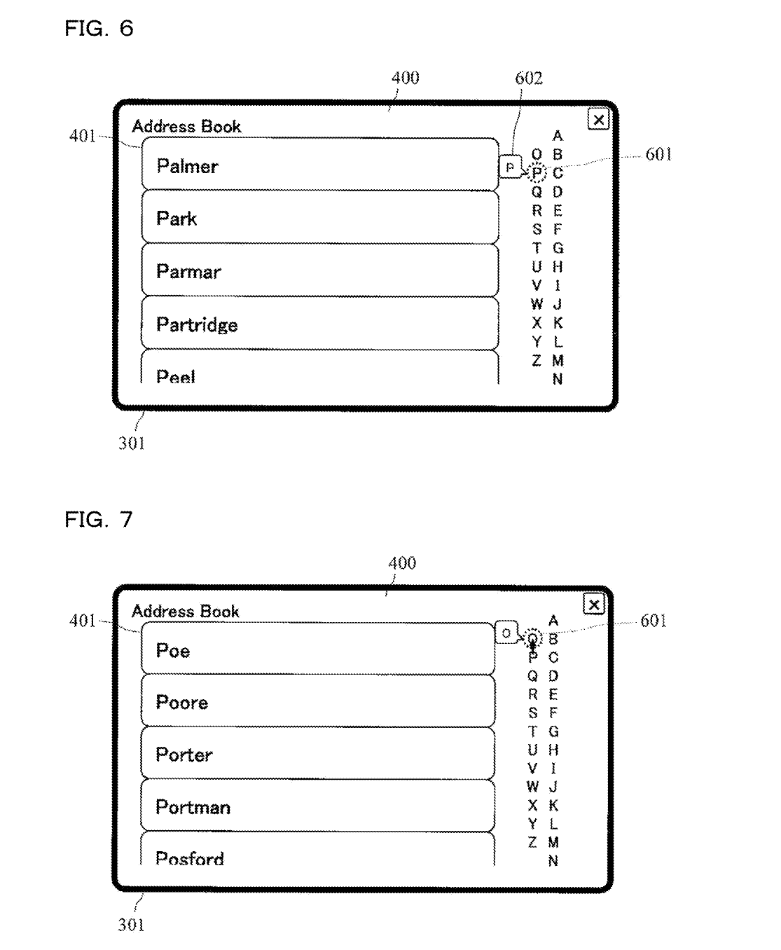

For example, FIG. 6 shows a state that the user is pressing the character “P” included in the character group for input on the search screen 400 shown in FIG. 4. FIG. 6 shows a pressed position 601 pressed by the user by the dotted line. At this time, the character “P” which is a target of selection is displayed on the touch panel 301 by the character display portion 303. In this example, the character “P” enclosed in a callout 602 is displayed on the left side of the pressed position 601. When the pressed position 601 stays on the character “P” for the minimum pressing time or longer, the search character input portion 302 designates the character “P” as the search character, and inputs the character in the search portion 313. As a result, the destination information beginning with the character “P” extracted by the search portion 313 is displayed in the search result display area 401. Thus, the search result is displayed in the search result display area 401, whereby, the user can recognize the input search character. When a wrong search character is input, the user may input a right search character after the pressing is cancelled.

In the state shown in FIG. 6, a case is assumed where the user has moved the pressed position 601 onto the character “O” without cancelling the pressing. In this case, as shown in FIG. 7, the character “O” which is the target of selection is displayed on the left side of the pressed position 601 by the character display portion 303 in a state of being enclosed in the callout 602. When the pressed position 601 stays on the character “O” for the minimum pressing time or longer, the search character input portion 302 designates the character “O” as the search character. In this case, the character “P” and character “O” are sequentially specified by a series of dragging operations without cancelling the pressing, and therefore the search character input portion 302 inputs the character string “PO” in the search portion 313. As a result, the destination information beginning with the character string “PO” extracted by the search portion 313 is displayed in the search result display area 401.

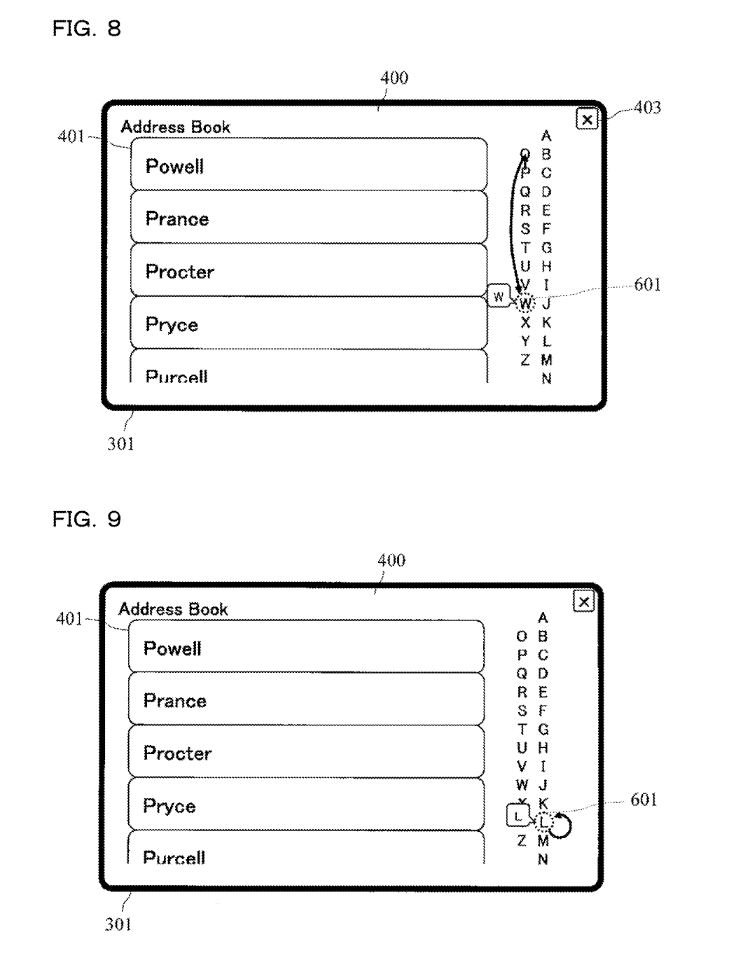

In the state shown in FIG. 7, a case is assumed where the user has moved the pressed position 601 onto the character “W” without cancelling the pressing. In this case, as shown in FIG. 8, the character “W” which is the target of selection is displayed on the left side of the pressed position 601 by the character display portion 303 in a state of being enclosed in the callout 602. When the pressed position 601 stays on the character “W” for the minimum pressing time or longer, the search character input portion 302 designates the character “W” as the search character. In this case, the character “P”, the character “O”, and the character “W” are sequentially designated by a series of dragging operations without cancelling the pressing, and therefore the search character input portion 302 inputs the character string “POW” in the search portion 313. As a result, the destination information beginning with the character string “POW” extracted by the search portion 313 is displayed in the search result display area 401.

In this state, for example, when the pressing on the character “W” is cancelled, and the destination information “Powell” displayed in the search result display area 401 is pressed, the address information associated with the destination information “Powell” is set as the destination of transmission of the facsimile. Such selection of destination of transmission can be also made in the search result displayed in the search result display area 401 at the point when the character “P” is input, or the search result displayed in the search result display area 401 at the point when the character “P” and character “O” are input.

Regardless of a series of dragging operations, when the pressing is cancelled among the character “P”, the character “O”, and the character “W”, the destination information beginning with the character “P”, the destination information beginning with the character “O”, and the destination information beginning with the character “W” are displayed in the search result display area 401 as the respective search results.

In addition, when the same characters are input in a row, the pressed position may be temporarily moved from the character to a location other than the character while the pressing state is maintained, and the pressed position may be moved again onto the character. For example, when the character “L” is input in a row, first, the user causes the pressed position 601 to stay on the character “L” and designates the character “L” as the search character. Thereafter, as shown in FIG. 9, the user temporarily moves the pressed position 601 from the character “L” to another location without cancelling the pressing, and then moves the pressed position 601 onto the character “L”. When the pressed position 601 stays on the character “L” for the minimum pressing time or longer, the character “L” is designated as the search character. Accordingly, the character string “LL” is designated as the search character by the search character input portion 302.

By the way, in the embodiment described above, the twenty six alphabets are disposed in the character display area for input 402, but multiple types of characters can be also assigned to a character displayed in the character display area for input. The constitution will be described below based on a case of input of hiragana characters. It should be noted that the following constitution can be of course applied to alphabets.

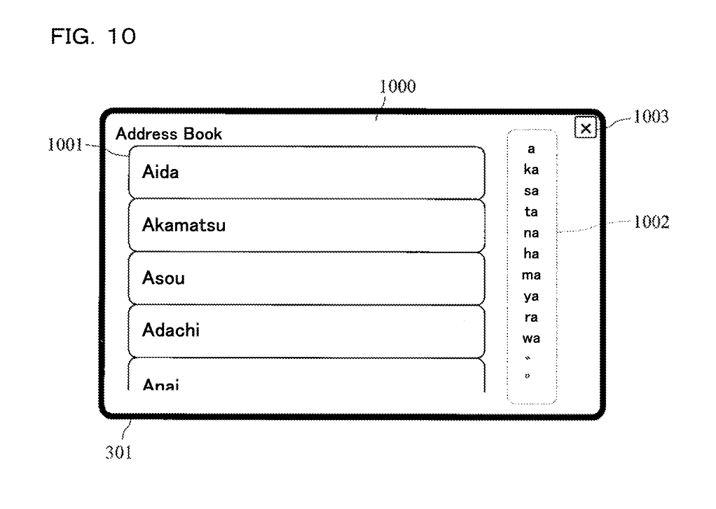

FIG. 10 is a diagram showing another example of the search screen displayed on the display surface of the touch panel 301 when a search is executed. As shown in FIG. 10, a search screen 1000 is provided with a search result display area 1001, a character display area for input 1002 and a forcible search termination button 1003.

The search result display area 1001 displays the result of the search of the search target data with a search target character string. In the example shown in FIG. 10, as in the example of FIG. 4, the search target data is the address book data. Herein, a state that a search character string has not been input is shown. Although not particularly limited, in this example, in such a situation that the search character string has not been input, destination information constituting the address book data in the search result display area 1001 is displayed in the order of the fifty hiragana characters. It should be noted that the search result display area 1001 can be moved in the vertical direction in FIG. 10 by dragging on the search result display area 1001, and the data which is not displayed in the display surface of the touch panel 301 can be displayed in the display surface of the touch panel 301.

The character display area for input 1002 displays a character group for input. In this example, the hiragana characters on the “a” row, a dakuten (sonant mark) and a handakuten (P-sound consonant mark) are displayed as a character string for input. The hiragana characters of each column are assigned to each of the hiragana characters. That is, the characters “a”, “i”, “u”, “e”, and “o” are assigned to the character “a”. It should be noted that the characters “ya”, “yu”, and “yo” are assigned to the character “ya”, and the characters “wa”, “wo”, and “n” are assigned to the character “wa”. The character group for input is a group including a plurality of characters each of which is associated with each character in advance, and are not necessarily Japanese hiragana characters, but may be also alphabets or other characters used in other languages.

As will be described later, the user inputs a search character by pressing on a character included in the character group for input displayed on the character display area for input 1002. When a character with a dakuten or handakuten attached thereto is input as a search character, the user inputs, after he/she inputs a hiragana character with no dakuten or handakuten, a dakuten or handakuten.

The forcible search termination button 1003 is used to forcibly terminate the search screen 1000. That is, when the forcible search termination button 1003 is pressed, the search screen 1000 is terminated, and a menu screen and the like are displayed on the display surface of the touch panel 301.

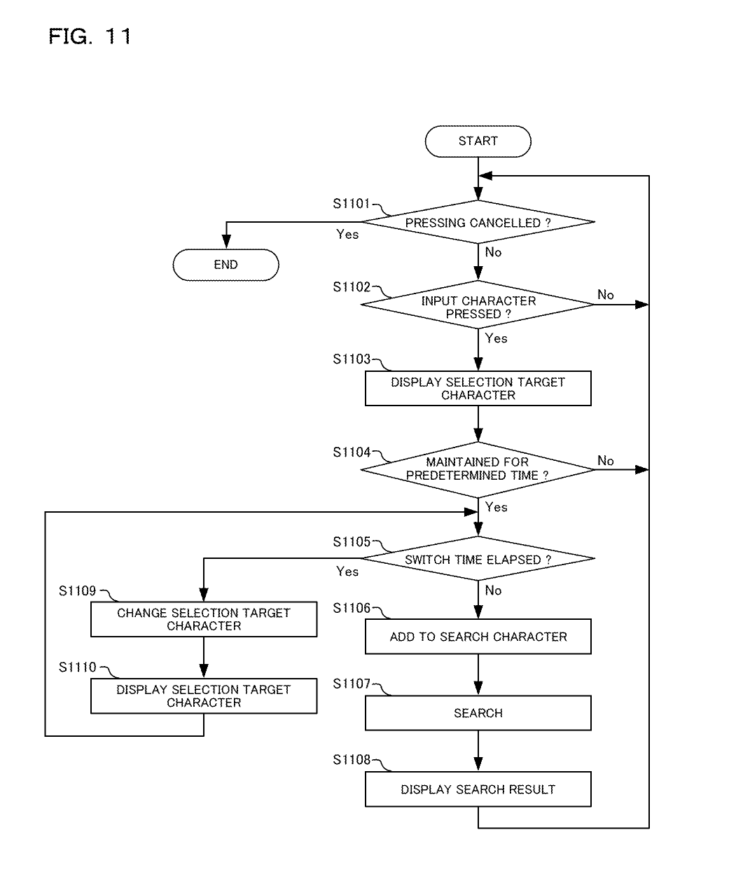

FIG. 11 is a flowchart showing another example of a search character input procedure performed by the search interface device 300. The procedure, for example, starts triggered by the events that the search screen 1000 stated above is displayed on the touch panel 301 by the selection on the menu screen and that the pressing on the search screen 1000 is detected. Herein, a case where the destination of transmission of a facsimile is searched from an address book data and designated will be described.

When the procedure starts, the search character input portion 302 waits until a character included in the character group for input displayed on the character display area for input 1002 is pressed on the touch panel 301 (step S1101: No, S1102: No). When the character is pressed, the search character input portion 302 recognizes the character, and notifies the character display portion 303 of the recognized character (step S1101: No, S1102: Yes). The notified character display portion 303 displays the notified character which is the target of selection on the touch panel 301 (step S1103).

At this time, the search character input portion 302 determines whether the pressing on the character has lasted for the minimum pressing time or longer designated in advance (step S1104). When the pressing does not last for the minimum pressing time or longer, the search character input portion 302 waits until a character included in the character group for input is pressed (step S1104: No, S1101: No, S1102: No).

When it is determined that the pressing has lasted for the minimum pressing time or longer, the search character input portion 302 determines whether the pressing on the character has lasted for a character switch time (for example, 2 to 3 seconds) or longer which is designated in advance (step S1104: Yes, S1105). When the pressing has not lasted for the character switch time or longer, the search character input portion 302 designates the character as a search character (step S1105: No, S1106). The search character input portion 302 which has designated the search character inputs the designated character in the search portion 313. Herein, the designated character is the first character, and therefore, only one character is input in the search portion 313. In response to the input, the search portion 313 extracts the data including the search character from the search target data contained in the storage portion 314, and displays the extracted result in the search result display area 1001 (step S1107, S1108).

In contrast, when the pressing has lasted for the character switch time or longer, the search character input portion 302 changes the selection target character to, among multiple types of characters assigned to the character, the character which is designated to be displayed in the second place (step S1105: Yes, S1109). At this time, the search character input portion 302 notifies the character display portion 303 of the character. The notified character display portion 303 displays the notified character which is the target of selection on the touch panel 301 (step S1110).

At this time, when the pressed position moves from the character to another location, the search character input portion 302 designates the character which was the selection target character at that point (step S1105: No, S1106). The search character input portion 302 which has designated the search character inputs the designated character in the search portion 313. Herein, the designated character is the first character, and therefore only one character is input in the search portion 313. In response to the input, the search portion 313 extracts data including the search character from the search target data contained in the storage portion 314, and displays the extracted result in the search result display area 1001 (step S1107, S1108).

When the pressing on the character is continued until the character switch time elapses from the point that the selection target character is changed, the search character input portion 302 changes the selection target character to, among multiple types of characters assigned to the character, the character which is designated to be displayed in the third place (step S1105: Yes, S1109). At this time, the search character input portion 302 notifies the character display portion 303 of the character. The character display portion 303 which has been notified of the character displays the notification selection target character on the touch panel 301 (step S1110). It should be noted that among multiple types of characters assigned to the character, as for the character which is designated to be displayed in the last place, when the pressing on the character has been continued until the character switch time elapses from the point that the selection target character is changed, the search character input portion 302 changes the selection target character to, among multiple types characters assigned to the character, the character which is designated to be displayed in the first place. Accordingly, any one of multiple types of characters assigned to one character can be selected depending on the time that the pressing state on the character was maintained.

The search character input portion 302 repeats the procedure stated above while the pressing state is maintained (S1101: No). For example, when the pressed position moves while the pressing state is still maintained, and moves onto another character, the character being the target of selection is displayed on the touch panel 301 by the character display portion 303 (step S1103). The search character input portion 302 determines whether the pressing on the character has lasted for the minimum pressing period or longer, and further, regarding the character, designates the search character by determining whether the pressing is maintained until the character switch time elapses from the point that the selection target character is changed (step S1104: Yes, S1105: Yes, S1109, S1110, S1105: No). The search character input portion 302 which has designated the search character inputs a character string composed of the newly designated character with the previously designated character added thereto in the search portion 313. Herein, the designated character is the second character, and therefore, a character string composed of the previously designated first character and the second character is input in the search portion 313.

In response to the input, the search portion 313 extracts data including the search character from the search target data contained in the storage portion 314, and displays the extracted result in the search result display area 1001 (step S1107, S1108).

It should be noted that when the pressing has been cancelled in the process of the above procedure, the procedure ends (step S1101: Yes).

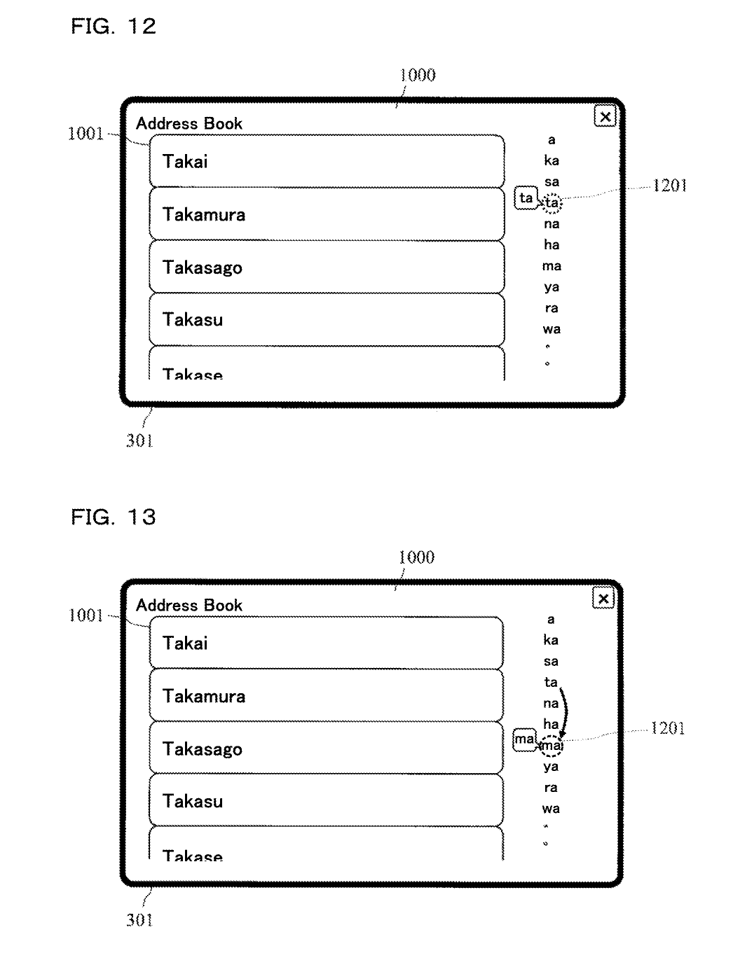

For example, FIG. 12 shows a state that the character “ta” included in the character group for input is pressed by the user on the search screen 1000 shown in FIG. 10. In FIG. 12, a pressed position 1201 pressed by the user is displayed by the dotted line. At this time, the character “ta” which is a target of selection is displayed on the touch panel 301 by the character display portion 303. In this example, the character “ta” enclosed in a callout 1202 is displayed on the left side of the pressed position 1201. When the pressed position 1201 stays on the character “ta” for the minimum pressing time or longer, and moves to another location before the character switch time elapses, the search character input portion 302 designates the character “ta” as the search character, and inputs the character in the search portion 313. As a result, the destination information beginning with the character “ta” extracted by the search portion 313 is displayed in the search result display area 1001.

In the state shown in FIG. 12, a case is assumed where the user moves the pressed position 1201 onto the character “ma” without cancelling the pressing. In this case, as shown in FIG. 13, the character “ma” which is the target of selection is displayed by the character display portion 303 on the left side of the pressed position 1201 in a state of being enclosed in the callout 1202.

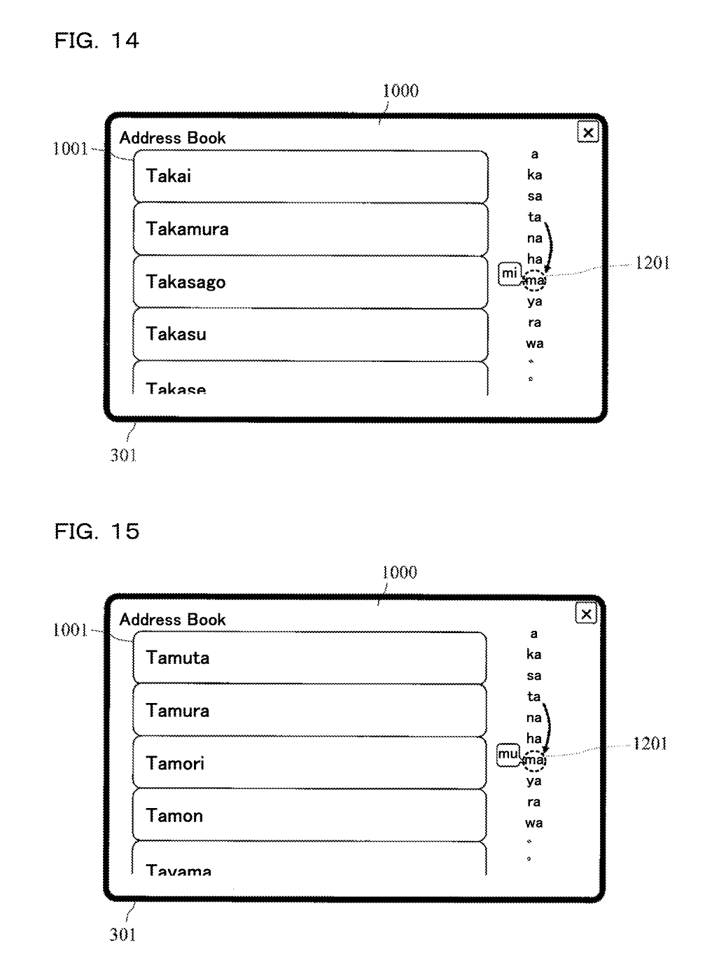

When the pressed position 1201 stays on the character “ma” for the minimum pressing time or longer, and stays until the character switch time elapses, the search character input portion 302 changes the selection target character to, among multiple types of characters (herein, “ma”, “mi”, “mu”, “me”, “mo”) assigned to the character, the character “mi” which is designated to be displayed in the second place. In this case, as shown in FIG. 14, the character “mi” being the selection target is displayed in a state of being enclosed in the callout 1202 on the left side of the pressed position 1201 by the character display portion 303.

When the pressed position 1201 stays on the character “ma” from when the character “mi” is displayed until the character switch time further elapses, the search character input portion 302 changes the selection target character to, among multiple types of characters assigned to the character, the character “mu” which is designated to be displayed in the third place. In this case, as shown in FIG. 15, the character “mu” being the selection target is displayed by the character display portion 303 on the left side of the pressed position 1201 in a state of being enclosed in the callout 1202.

When the pressed position 1201 moves from the character “ma” to another location before the character switch time elapses from when the character “mu” is displayed, the search character input portion 302 designates the character “mu” as the search character. In this case, the character “ta” and the character “mu” are sequentially designated by a series of dragging operations without cancelling of the pressing. Accordingly, the search character input portion 302 inputs the character string “tamu” in the search portion 313. As a result, in the search result display area 1001 as shown in FIG. 15, destination information beginning with the character string “tamu” extracted by the search portion 313 is displayed. In this state, for example, when the pressing on the character “ma” is cancelled, and the destination information “tamura” displayed in the search result display area 1001 is pressed, the address information associated with the destination information “tamura” is set as the destination of transmission of the facsimile.

In addition, when the same characters are input in a row, as stated above, the pressed position may be temporarily moved from the character to a location other than the character while the pressing state is maintained, and the pressed position may be moved again onto the character.

In the constitution described above, it is possible to employ such a constitution in which when the selection target character is changed to multiple types of characters assigned to one character according to the order of display, the search character input portion 302 temporarily specifies the selection target character as the search character. For example, in the example stated above, the search character is not specified in the process that the selection target character is changed from the character “ma” to the character “mi”, and to the character “mu”, and therefore the destination information beginning with the character “ta” specified previously is displayed in the search result display area 1001. Then, at the point when the destination information beginning with the character “mu” is specified as the search character, the character string “tamu” is displayed in the search result display area 1001.

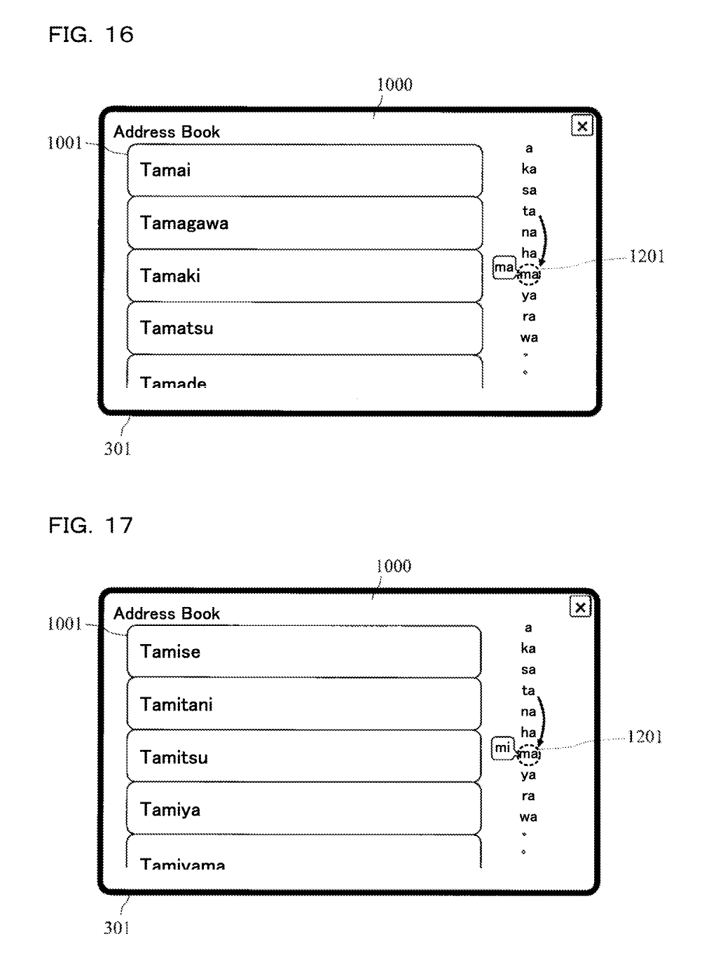

In contrast, in such a constitution that the search character input portion 302 temporarily specifies the selection target character as the search character, when the selection target character is the character “ma”, the character “ma” is temporarily specified as the search character, and the search character input portion 302 inputs the character string “tama” in the search portion 313. As a result, in the search result display area 1001 as shown in FIG. 16, the destination information beginning with the character string “tama” extracted by the search portion 313 is displayed. Moreover, when the selection target character is the character “mi”, the character “mi” is temporarily specified as the search character, and the search character input portion 302 inputs the character string “tami” in the search portion 313. As a result, in the search result display area 1001 as shown in FIG. 17, the destination information beginning with the character string “tami” extracted by the search portion 313 is displayed.

As explained above, in this multifunction peripheral 100, search characters can be input continuously and easily, without disposing an input interface such as a software keyboard which occupies a large space on the display surface. Therefore, for example, it is possible to display the display area of search results and the input interface on the same screen even with a touch panel having a small screen size.

In addition, this multifunction peripheral 100 is provided with the character display portion 303, and therefore the user can recognize the input characters more reliably.

Furthermore, in such a constitution that multiple types of characters are assigned to a character displayed in the character display area for input, the number of the characters displayed in the character display area for input can be decreased.

It should be noted that the embodiments mentioned above are not to limit the technical scope of this disclosure, and various deformations and applications other than those already described can be made within the scope of this disclosure. For example, in the above embodiments, the application to the address book function is shown as a specific example, but it can be applied not only to searching the address book function, but also to searching operation histories, searching electronic program tables and other optional searching. In addition, in the embodiments described above, the case of application to a prefix search has been described, but can be applied to any search method such as middle matches and backward matches. Furthermore, the combinations and arrangements of the character group for input displayed in the character display areas for input 402, 1002 can be optionally selected.

In addition, in the flowcharts shown in FIGS. 5 and 11, the order of the steps and the like can be suitably changed in such a scope that can produce equivalent effects.

In addition, in the embodiments described above, this disclosure was embodied as a digital multifunction peripheral, but this disclosure can be also applied not only to digital multifunction peripherals, but also to portable information terminals and any other electronic devices. Furthermore, this disclosure can be also applied to any search interface device used to input characters for searching search target data.

According to this disclosure, the invention does not suffer lowered operability even with a small sized screen, and is useful as a search interface device and an electronic device.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. A search interface device used to input characters for searching search target data, the search interface device comprising:
a touch panel having a display surface including a search result display area for displaying a search result and a character display area for input which displays a character group for input, the touch panel which being configured to detect a pressed position on the display surface; and
a search character input portion configured to input, in response to movement of the pressed position in a state that pressing on a plurality of characters included in the character group for input displayed in the character display area for input is maintained, a character corresponding to the pressed position sequentially as a search character.

2. The search interface device according to claim 1, wherein the search character input portion inputs, when the pressed position moves in a state that the pressing on the plurality of characters included in the character group for input displayed in the character display area for input is maintained, the character corresponding to the pressed position on which halt of movement is maintained for a predetermined period of time, sequentially as a search character.

3. The search interface device according to claim 1, further comprising a character display portion configured to display a target character which is input as the search character when the pressed position is located on a character included in the character group for input.

4. The search interface device according to claim 1, wherein multiple types of characters are assigned to a character displayed in the character display area for input, and the search character input portion inputs any of the assigned multiple types of characters, which is selected depending on the time during which pressing on the character is maintained.

5. An electronic device comprising the search interface device according to claim 1.
